(19) United States
(12) Patent Application Publication
(10) Pub. No.: US 2023/0150055 A1
(43) Pub. Date: May 18, 2023

(54) METHOD FOR MONITORING A LASER WELDING PROCESS FOR WELDING TWO WORKPIECES WITH REGARD TO A BRIDGED GAP

(71) Applicant: TRUMPF Laser- und Systemtechnik GmbH, Ditzingen (DE)

(72) Inventors: Tim Hesse, Ditzingen (DE); Sebastian Hecker, Salem (DE)

(21) Appl. No.: 18/156,413

(22) Filed: Jan. 19, 2023

Related U.S. Application Data
(63) Continuation of application No. PCT/EP2021/070118, filed on Jul. 19, 2021.

(30) Foreign Application Priority Data
Jul. 31, 2020 (DE) 10 2020 209 700.3

(51) Int. Cl. B23K 26/03; B23K 26/0622; B23K 26/24; B23K 26/324; C03B 23/20; C03B 23/00

(52) U.S. Cl. CPC B23K 26/032; B23K 26/0622; B23K 26/24; B23K 26/324; C03B 23/20; C03B 23/0086

(57) ABSTRACT

A method for monitoring a laser welding process for welding two workpieces using a laser wavelength, in which a pulsed laser beam is directed into the workpieces so as to melt a melting volume in a region of an interface of the two workpieces in order to produce a weld seam, and in which an intensity of a process radiation emitted by the melting volume is detected. According to the method for monitoring the lase welding process, in a first step, a detected intensity profile is evaluated with regard to at least one of the following features: (i) a depth of an intensity decrease, (ii) a duration of an intensity decrease, and (iii) a renewed increase in intensity after an intensity decrease. In a second step it is determined whether or not a gap between the two workpieces was bridged during the laser welding process based on the evaluation.

### CROSS REFERENCE TO RELATED APPLICATIONS

This application is a continuation of International Application No. PCT/EP2021/070118 (WO2022/023099A1), filed on Jul. 19, 2021, and claims benefit to German Patent Application No. DE 10 2020 209 700.3 A1, filed on Jul. 31, 2020. The aforementioned applications are hereby incorporated by reference herein

### FIELD

The present invention relates to a method for monitoring a laser welding process for welding two workpieces, preferably composed of glass, that are transparent to the laser wavelength, in which, in the workpieces, a pulsed laser beam, in particular ultrashort pulse laser beam, melts a melting volume in the region of the interface of the two workpieces in order to produce a weld seam, and in which the intensity of the process radiation emitted by the melting volume is detected.

### BACKGROUND

Such a monitoring method has been disclosed by DE 10 2018 128 377 A1, for example.

The quality control of two laser-welded workpieces composed of glass is usually effected in a work step downstream of the welding processing. In this case, the welded final workpiece is often subjected to laborious manual inspection. A microscope is used to determine whether or not a gap was bridged. The position and the size of the gap have hitherto been examined by microscopy in a complex manner on the basis of transverse microsections after the end of the process. Strength measurements are additionally carried out.

DE 10 2018 128 377 A1 discloses a method for monitoring a welding process for welding two workpieces composed of glass, in which, in the workpieces, a weld seam is formed in a process zone exposed to a pulsed ultrashort pulse laser beam. The intensity of the process radiation emitted by the process zone is detected in a temporally resolved manner and the periodicity, the frequency and the frequency spectrum of intensity fluctuations of the detected process radiation are determined in order to deduce the quality of the produced weld seam therefrom.

### SUMMARY

In an embodiment, the present disclosure provides a method for monitoring a laser welding process for welding two workpieces using a laser wavelength, wherein the two workpieces are transparent to the laser wavelength, and in which a pulsed laser beam is directed into the workpieces so as to melt a melting volume in a region of an interface of the two workpieces in order to produce a weld seam, an intensity of a process radiation emitted by the melting volume being detected. The method includes evaluating a detected intensity profile with regard to at least one of the following features: (i) a depth of an intensity decrease, (ii) a duration of an intensity decrease, and (iii) a renewed increase in intensity after an intensity decrease. In addition, the method includes determining whether or not a gap between the two workpieces was bridged during the laser welding process based on the evaluation.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of an apparatus for monitoring a laser welding process for welding two workpieces composed of glass; and

FIGS. 2A-f show measured temporal intensity profiles of the emitted process radiation during the laser welding of two workpieces composed of quartz glass, for various gap widths.

### DETAILED DESCRIPTION

The present invention addresses the problem of developing the monitoring method mentioned in the introduction to the effect that, when joining transparent workpieces, a bridged gap can be identified in order thus to establish whether or not integral bonding has taken place.

In the case of the monitoring method mentioned in the introduction, an aspect of the invention is to evaluate the detected intensity profile with regard to at least one of the following features:
depth of an intensity decrease, for example, caused by molten material being ejected from the melting volume into a gap between the workpieces,
duration of an intensity decrease, and
renewed increase in the intensity after an intensity decrease,

and that this evaluation is taken as a basis for determining whether or not the gap was bridged during the laser welding process.

Traditionally, a Gaussian beam is used for focusing into the glass volume near the interface and for producing a melting volume. In that case, in particular over a plurality of pulses, the absorption is pulled in the direction of the incident wavefront since a preferred absorption occurs there on account of the increased temperature. The longitudinal position of the local energy introduction thus varies across a plurality of pulses as a result of shielding. If the absorption region is displaced too far into the convergent beam, the energy introduction declines, and the process starts anew, proceeding from the focus, and a further melting volume is formed. This typically results in modulated weld seams with periodically juxtaposed, possibly overlapping, melting volumes (periodic signature). If the interface lies within the melted volume, integral bonding occurs. However, if there is a gap between the workpieces to be joined, melt is impulsively expelled into the gap by virtue of the prevailing pressure within the process zone. If the gap between the workpieces is completely filled with material so that the absorption can be continued in the second glass, integral bonding occurs. The position and the size of the gap influence the strength and the visibility of the welding connection. However, if the melt spreads extensively in the gap, the absorption cannot be maintained. The gap is not bridged, and integral bonding does not occur. During processing, the interaction zone emits process radiation with a continuous spectrum. If melt is ejected into the gap, the material spreads in the gap and cools down. This has the effect that the intensity of the emitted process radiation declines and less laser radiation is absorbed. A short emission peak may occur before the radiation emission declines. If the absorption can be continued despite molten material being ejected, the intensity of the process radiation increases again and is discontinued if the process shifts too far in the direction of the convergent beam.

In order to identify already in the course of laser welding whether or not a gap was bridged, according to the invention the depth and/or duration of the intensity decrease and/or the renewed increase in the intensity after an intensity decrease are evaluated and a bridged or non-bridged gap is deduced therefrom. If the intensity does not decline fully and increases again, the gap was bridged. If the intensity declines fully and is not continued, the gap was not bridged. Since the decline in the radiation emission may be observed equally over the entire emission spectrum, detection is possible over a large wavelength range or wavelength-selectively. According to the invention, the evaluation can take place on the basis of the detected intensity profile of the individual melting volumes or on the basis of a temporally averaged intensity profile, e.g. an intensity profile integrated over each melting volume.

Depth and duration of the intensity decrease and renewed increase in the intensity can be evaluated independently of one another and indicate a gap independently of one another. An intensity increase after the intensity decline indicates a bridged gap, i.e. the weld seam is continued despite a gap in the upper material.

Preferably, the gap width of a bridged gap, which width influences the quality of the welding connection, will be ascertained on the basis of the depth and the duration of the intensity decrease of the detected process radiation.

The detected intensity profile can advantageously also additionally be evaluated with regard to the point in time of the intensity decrease or with regard to the point in time of an intensity peak preceding the intensity decrease, in order to ascertain the position of a bridged gap therefrom.

Further advantages and advantageous configurations of the subject matter of the invention can be gathered from the description, the drawings and the claims. Likewise, the features mentioned above and those that will also be presented further can be used in each case by themselves or as a plurality in any desired combinations. The embodiments shown and described should not be understood as an exhaustive enumeration, but rather are of exemplary character for outlining the invention.

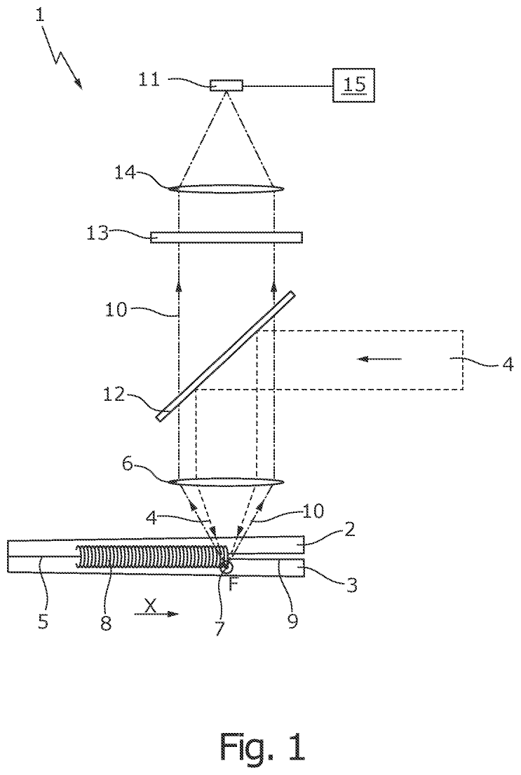

The apparatus 1 shown schematically in FIG. 1 serves for monitoring a laser welding process for welding two workpieces 2, 3 composed of a material that is transparent to the laser wavelength, e.g. composed of glass, which lie one on top of the other and are in the form of sheets here merely by way of example, by means of a pulsed laser beam 4. An ultrashort pulse laser beam having pulses in the femto- or picoseconds range and having frequencies of the repetition rates of from 100 kHz to several MHz is preferably used as the pulsed laser beam 4.

The underside of the upper workpiece 2 in FIG. 1 and the top side of the lower workpiece 3 bear against one another and form an interface 5, in which the welding is intended to be performed or was performed. The laser beam 4 is focused by a processing optical unit 6 through the upper workpiece 2 into the lower workpiece 3 near the interface 5 in order to produce a melting volume 7 there. An ultrashort pulse laser is preferably used, the average power of which is temporally modulated. Preferably, the processing parameters are chosen such that an individual melting volume 7 is produced with each modulation period.

As a result of the very high intensities achievable in the process at the focus F, nonlinear absorption effects occur in the glass material. Given suitable repetition rates of the pulsed laser beam 4, heat accumulation effects occur in the glass material, whereby local melting of the glass material occurs. The melting volume 7 is accordingly positioned in the workpieces 2, 3 such that it is arranged near the interface 5 or encompasses the interface 5. When the formerly melted material solidifies again, the workpieces 2, 3 are welded in an integrally bonded manner. The laser beam 4 is moved jointly with the processing optical unit 6 in a feed direction X relative to the workpieces 2, 3 in order to introduce a weld seam 8 in the workpieces 2, 3.

In particular over a plurality of pulses, the absorption in the lower workpiece 3 is pulled in the direction of the incident laser beam 4 since a preferred absorption occurs there on account of the increased temperature. The longitudinal position of the local energy introduction thus varies across a plurality of pulses as a result of shielding. If the absorption region is displaced too far into the convergent beam, the energy introduction declines, and the process starts anew, proceeding from the focus F. This typically results in modulated weld seams 8 with a periodic signature.

If the interface 5 lies within the molten melting volume 7, integral bonding occurs. If there is a gap 9 between the workpieces 2, 3 to be joined, melt is impulsively expelled into the gap 9 by virtue of the prevailing pressure within the process zone. If the gap 9 between the workpieces 2, 3 is completely filled with material so that the absorption can be continued in the upper workpiece 2, integral bonding occurs. However, if the melt spreads extensively in the gap 9, the absorption cannot be maintained. The gap 9 is not bridged, and integral bonding does not occur. The position and the size of the gap 9 influence the strength and the visibility of the welding connection and also affect the intensity of the process radiation 10 emitted by the interaction zone of the laser beam 4 in the workpiece 2, 3 during the process.

The intensity of the emitted process radiation 10 is established by a detector arranged preferably coaxially with respect to the laser beam 4, here in the form of a photodiode 11. Alternatively, the detector can also be mounted next to the processing optical unit 6 or below the workpieces 2, 3 (“off-axis”). Instead of a photodiode, a fast linear array sensor or a camera can also be used to detect the emitted process radiation 10.

By means of a dichroic mirror 12, which for example is highly reflective for the laser wavelength and transmissive for radiation in the visible wavelength range of 300 to 800 nm, the laser beam 4 is guided to the processing optical unit 6 and focused just below the interface 5 in the lower workpiece 3. Alternatively, the dichroic mirror 12 can also be transmissive for the laser wavelength and reflective for the process radiation 10. Instead of or in addition to the visible wavelength range, the process radiation 10 can also be observed in the infrared wavelength range. The process radiation 10 emitted here by the process zone of the workpieces 2, 3 is captured with the aid of the processing optical unit 6 and coupled out of the laser beam path through the dichroic mirror 12. An optical filter element 13 serves for selecting a desired wavelength range and/or for suppressing reflected laser radiation from the process radiation 10. Downstream of the filter element 13, the process radiation 10 is focused onto the photodiode 11, e.g. by means of a lens 14. A monitoring unit 15 is used to evaluate the temporal intensity profile of the emitted process radiation 10 for each produced melting volume in respect of a change in the radiation intensity which allows a bridged gap to be inferred.

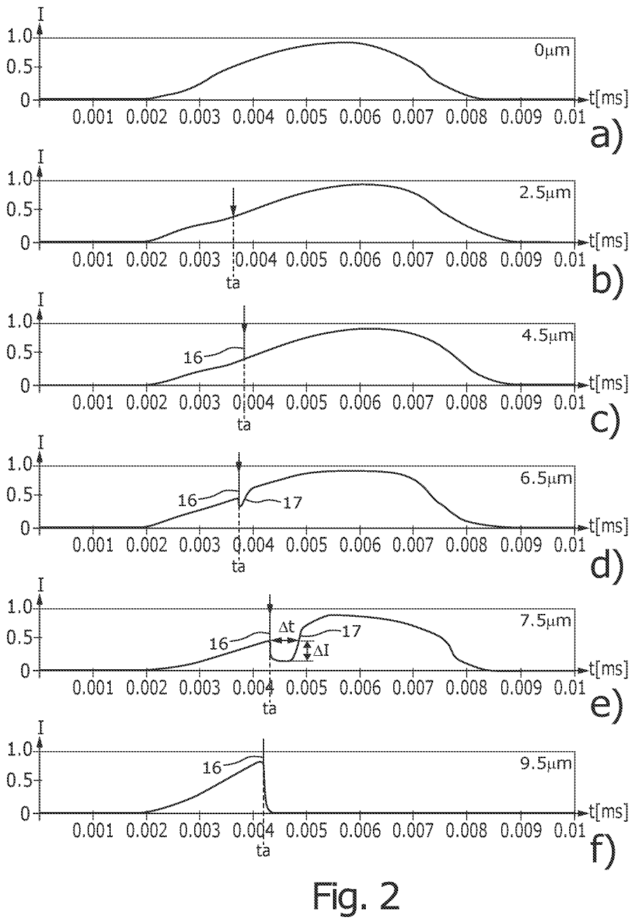

FIGS. 2A-f show exemplary temporal intensity profiles I(t) of the emitted process radiation 10 during the laser welding of two workpieces 2, 3 composed of quartz glass, for various gap widths. Process radiation 10 with a continuous spectrum is emitted during the laser processing.

FIG. 2a shows the intensity profile when there is no gap between the two workpieces 2, 3, i.e. the gap width is 0 μm.

FIGS. 2b-f Show the intensity profiles for different gap widths between 2.5 μm and 9.5 μm. If melt is ejected into a gap 9, the material spreads in the gap 9 and cools down. This has the effect that the intensity of the process radiation 10 declines at a point in time t_{A} and less laser radiation is absorbed. If the gap 9 between workpieces 2, 3 is completely filled with material, the absorption can be continued in the upper workpiece 2, i.e. the intensity does not decrease to zero and increases again, whereby the gap 9 is bridged (FIGS. 2a-e). If, by contrast, as shown in FIG. 2f, the intensity declines fully and does not increase again, the gap 9 was not bridged. A short emission peak or intensity peak 16 occurs before the process radiation 10 declines.

The position of the gap 9 within the melting volume can be deduced on the basis of the measured point in time t_{A}. The later the ejection of molten material takes place, the higher the location of the gap 9 within the produced melting volume 7. The size of the bridged gap 9 can additionally be estimated on the basis of the depth ΔI of the intensity decrease and the temporal duration Δt of the intensity decrease. The greater the decline in the intensity and the longer it takes for the process radiation 10 to increase again, the larger the bridged gap 9. An intensity increase 17 after the intensity decline as shown in FIGS. 2d and 2e indicates a bridged gap 9, i.e. the weld seam 8 is continued despite a gap 9 in the upper workpiece 2. With the aid of the method described, it is possible to carry out the quality inspection of welding connections on an industrial scale directly during processing, as a result of which laborious manual inspection downstream of the process can be obviated.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for monitoring a laser welding process for welding two workpieces using a laser wavelength, wherein the two workpieces are transparent to the laser wavelength, in which a pulsed laser beam is directed into the workpieces so as to melt a melting volume in a region of an interface of the two workpieces in order to produce a weld seam, an intensity of a process radiation emitted by the melting volume being detected, the method comprising:
evaluating a detected intensity profile with regard to at least one of the following features:
a depth of an intensity decrease,
a duration of an intensity decrease, and
a renewed increase in intensity after an intensity decrease, determining whether or not a gap between the two workpieces was bridged during the laser welding process based on the evaluation.

2. The method as claimed in claim 1, wherein the evaluating is performed with regard to at least the duration of the intensity decrease and further comprising ascertaining a width of the bridged gap based on the evaluated duration of the intensity decrease.

3. The method as claimed in claim 1, wherein the evaluating is additionally performed with regard to a point in time of the intensity decrease and further comprising ascertaining a position of the bridged gap is ascertained based on the additional evaluation.

4. The method as claimed in claim 1, wherein the evaluating is additionally performed with regard to a point in time of an intensity peak preceding an intensity decrease and further comprising ascertaining a position of a bridged gap or a non-bridged gapbased on the additional evaluation.

5. The method as claimed in claim 1, further comprising modulating an average laser power of the pulsed laser beam is modulated.

6. (canceled)
